(19) United States
(12) Patent Application Publication
(10) Pub. No.: US 2008/0025488 A1
(43) Pub. Date: Jan. 31, 2008

(54) Anonymous Communications Using Sender Based Routing

(76) Inventors: Ben Dean, Pleasanton, CA (US); Kyle Sims, Oakland, CA (US); Tupshin Harper, Berkeley, CA (US)

Correspondence Address: CARR & FERRELL LLP, 2200 GENG ROAD, PALO ALTO, CA, 94303, US

(21) Appl. No.: 11/734,667

(22) Filed: Apr. 12, 2007

Related U.S. Application Data
(63) Continuation-in-part of application No. 11/622,665, filed on Jan. 12, 2007.
(60) Provisional application No. 60/759,131, filed on Jan. 13, 2006.
(60) Provisional application No. 60/791,651, filed on Apr. 12, 2006.

(51) Int. Cl. H04M 3/42

(52) U.S. Cl. 379/201.11

(57) ABSTRACT

Anonymous communication features in a sender based routing network are provided. A single system-defined communication address is associated with a first user and a second user in lieu of the real communication addresses of the users. A communication from the real communication address of the first user is routed to the real communication address of the second user based on the single system-defined communication address and a unique identifier associated with the sender. Anonymous communications may then take place between the two users without actual knowledge of either user's real communication address.

### CROSS-REFERENCE TO RELATED APPLICATIONS

The present application is a continuation in part and claims the priority benefit of U.S. patent application Ser. No. 11/622,665 filed Jan. 12, 2005 and entitled “Systems and Methods for Sender Based Routing,” which claims the priority benefit of U.S. provisional patent application No. 60/759,131 filed Jan. 13, 2006 and entitled “Systems and Methods for Providing Communications Features”; the present application also claims the priority benefit of U.S. provisional patent application No. 60/791,651 filed Apr. 12, 2006 and entitled “Systems and Methods for Providing Anonymous Communications Features.” The disclosure of all the aforementioned applications is incorporated herein by reference.

### BACKGROUND OF THE INVENTION

1. Field of the Invention

The present invention relates generally to communications. More specifically, the present invention relates to providing anonymous communication features utilizing sender based routing.

2. Description of Related Art

Conventionally, users are connected to one another based on communication addresses assigned to the users. For example, a user calls a particular phone number to reach one or more users associated with the particular phone number. As another example, a user may send an electronic mail to one or more users associated with an electronic email address. Thus, any first user can contact a second user by using the communication address assigned to the second user.

Disadvantageously, the communication address can only be utilized to contact the user, or multiple users in some cases, associated with the particular communication address. Thus, each person or group of persons needs a unique communication address in order to be contacted through the system.

Further, for one person to communicate with another person generally requires the disclosure of the unique communication address associated with at least one person to the other person. This disclosure is usually made by at least the person receiving the communication such that they can be contacted by the person initiating the communication (i.e., to what address does the communication need to be sent). In many instances, however, as a result of having initiated the communication, that person's unique communication address is also disclosed (e.g., as may be identified by caller identification (caller ID) or in a ‘reply to’ setting for an electronic-mail address).

Some techniques exist to help maintain the confidentiality or anonymity of the person initiating the communication. For example, the person initiating the communication over a voice telephone network may ‘block’ a caller ID function possessed by the person receiving the telephone communication. Notwithstanding, the person being called still must disclose their phone number (i.e., their communication address) in order for the communication to take place.

In some instances, it may be desirable to maintain complete or near complete anonymity in communications using, for example, voice or text messaging (e.g., short message service (SMS)). Similar anonymity may be desirable with respect to other communications mediums (e.g., electronic mail and instant messaging). For example, in the case of meeting a new person to begin a possible relationship (e.g., a first date), it may be necessary for the two persons to communicate with one another in order to arrange logistics of a first meeting (e.g., what time, where, etc.). One or both persons may not wish to disclose certain communications information (e.g., a personal or work phone number). This desire may be in anticipation of one person avoiding subsequent contact with the other person should the relationship fail to materialize (e.g., to avoid subsequent ‘stalking’ after a bad date or a break-up). There is, therefore, a need in the art for anonymous communications between two persons without the need to disclose a private communication address.

### SUMMARY OF THE INVENTION

One embodiment of the presently disclosed invention provides an anonymous communications address. Through this method, data concerning a first user and a second user are provided. A common, single communication address is then assigned to both the first user and the second user. Future communications are then routed to the first and second user as is appropriate when either user utilizes the common communication address to contact the other user.

In another embodiment of the presently disclosed invention, anonymous communication addresses are provided in a social network. Registration data is received from a first user in the network. An invitation is then sent to a second user, the invitation indicating the desire of the first user to communicate with the second user. A common, single communication address is then assigned to both the first user and the second user. Future communications are then routed to the first and second user as is appropriate when either user utilizes the common communication address to contact the other user.

In a still further embodiment of the presently disclosed invention, an anonymous voice mail service is provided. A communication is received from a first user; the user is then placed on hold. A determination is made as to whether a second user sought to be contacted by the first user will accept the communication or whether the communication will be accepted by a voice mail service. If the communication will be accepted by the voice mail service, the first user is maintained on hold until an outgoing voice mail message associated with the second user ends. After the outgoing voice mail message ends, the first user is routed to the second user for the purpose of leaving a voice mail message.

In yet another embodiment of the presently disclosed invention, an alternative method for providing anonymous communication addresses is disclosed. In this method, data associated with a first user and a second user is received. A first communication address is assigned to the first user. The communication address assigned to the first user is further associated with communications initiated by the first user and intended for the second user. This intent may be reflected by the data associated with the first user. A second communication address is further assigned to the second user. The communication address assigned to the second user is further associated with communications initiated by the second user and intended for the first user. This intent may be reflected by the data associated with the second user. Communications between the first user and second user are appropriately routed between the two users when the first user initiates a communication with the second user using the communication address assigned to the first user or, alternatively, when the second user initiates a communication with the first user using the communication address assigned to the second user.

### BRIEF DESCRIPTION OF THE DRAWINGS

FIG. 1 illustrates a schematic diagram of an exemplary architecture for providing sender-based routing according to one embodiment;

FIG. 2 illustrates a schematic diagram of an exemplary architecture for providing sender-based routing over a voice network according to one embodiment;

FIG. 3 illustrates a schematic diagram of an exemplary architecture for providing sender-based routing over a voice network and/or a data network according to one embodiment;

FIG. 4 illustrates a flow diagram of an exemplary process for routing telephone calls based on a unique identifier associated with the sender according to one embodiment; and

FIG. 5 illustrates a flow diagram of an exemplary process for providing sender-based routing according to one embodiment.

FIG. 6 illustrates a flow diagram of an exemplary process for providing two-way anonymous voice communications utilizing standard phone and phone numbers according to one embodiment.

FIG. 7 illustrates a flow diagram of an exemplary process for providing two-way anonymous communications utilizing common short code (CSC) messaging according to one embodiment.

FIG. 8 illustrates a method for anonymous voice messaging according to one embodiment.

### DETAILED DESCRIPTION

Systems and methods for providing sender-based routing are provided. Various communications may be communicated utilizing the sender-based routing discussed herein. The sender data may be collected and utilized to issue or assign a unique identifier to the sender. For example, the unique identifier may comprise a phone number, an email address, or any other information associated with the sender that may be utilized to uniquely identify the particular sender. A communication from the sender may then be routed to another subscriber or recipient (including one at a different receiving device or system) based on the unique identifier of the user and a communication address that the sender, or other user, enters.

Exemplary embodiments of the present invention may allow for effective allocation of addresses to parties (human or machine) involved in exchanging information. Through such embodiments, it becomes possible to limit the number of network addresses required to support a disproportionately large number of subscribers. As a single entity may not need or have a relationship with all other entities in any particular network, embodiments of the present invention may allow for saving of address space relative to already existing communication systems and networks. Wasteful allocation of addresses may result in depletion of address space as evidenced by area code splits, increases in phone number length, transition from IPv4 and IPv6, and utilization of Network Address Translation (NAT) in IPv4 networks.

Sender based routing, in accord with the present disclosed invention, allows (for example) a 10-digit based phone number system without issues related to scalability. In a typical prior art solution, a 10-digit number may be assigned to every subscriber. Thus, a network with 10 million subscribers would require 10 million 10-digit numbers. Embodiments of the presently disclosed invention, however, may require only a few hundred numbers while still satisfying the millions of subscribers to the network. By assigning numbers based on relationships between subscribers, and utilizing sender-based routing to support multiples relationships via a single network address, the system need only provide the number of unique addresses required to support the subscriber with the most relationships. Such relationship-based assignments are applicable to phone numbers (for both voice and SMS/text messaging communication), email addresses, instant messaging addresses, and various other communications and messaging utilities.

Rights management by both parties in an exchange occurring through an embodiment of the present invention may allow for the initiation and termination of the relationship. Such rights management may further allow for protection of anonymity and privacy. Control over anonymity and privacy settings may aide in the management and delivery of unsolicited ‘junk mail.’ Such privacy controls may also overcome the unfair advantage of an originating party who does not need to disclose an originating address to the recipient, which prevents the receiving party from contacting the originating party. Such a disadvantage also prevents the receiving party from selectively blocking a particular originating party.

These and other advantages and benefits may become evident to one of skill in the art through the practice of the presently disclosed invention.

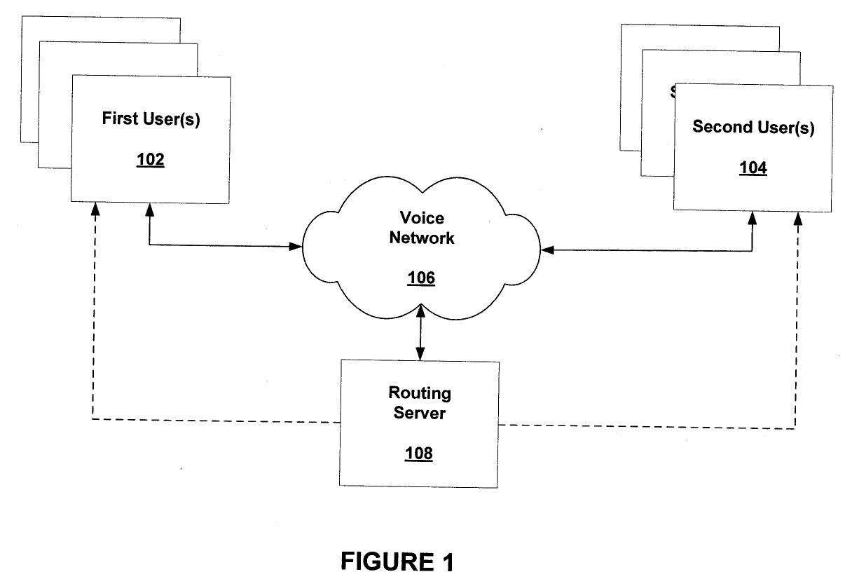

FIG. 1 illustrates a schematic diagram of an exemplary architecture for providing sender-based routing according to one embodiment. One or more first users 102 can communicate with one or more second users 104 via a voice network 106. The voice network 106 may include the public switched telephone network (PSTN), voice over IP (VoIP) or any other type of voice network 106 according to various embodiments.

A routing server 108 may be in communication with the voice network 106 for routing communications between the first user 102 and the second user 104. According to exemplary embodiments, the first user 102 sends a communication via the voice network 106. The voice network 106 recognizes a telephone number associated with the first user 102 as one of various telephone numbers that should be forwarded to the routing server 108. The routing server 108 identifies the first user 102 based on a unique identifier assigned to the first user 102. The routing server 108 then routes the communication to the second user 104 based on the telephone number entered and the unique identifier associated with the first user 102, or sender.

According to exemplary embodiments, the first user 102 and the second user 104 may each be assigned different communication addresses, such as telephone numbers, email addresses, and so forth. For example, the first user 102 and the second user 104 may each be assigned a local telephone number for one another. Thus, when the first user 102 calls the local telephone number, the communication is routed to the second user 104 based on the telephone number entered and the unique identifier associated with the first user 102, and vice versa. Accordingly, each of the first user 102 and the second user 104 can dial local phone numbers to reach one another.

In some embodiments, the voice network 106 includes the routing server 108 for directly routing the communications between the first user 102 and the second user 104. In other words, the voice network may forward communications to the routing server 108. The routing server 108 routes the communications between the first user 102 and the second user 104, or the voice network 106 may communicate with the routing server 108 in order to determine where the voice network 106 should route the communications.

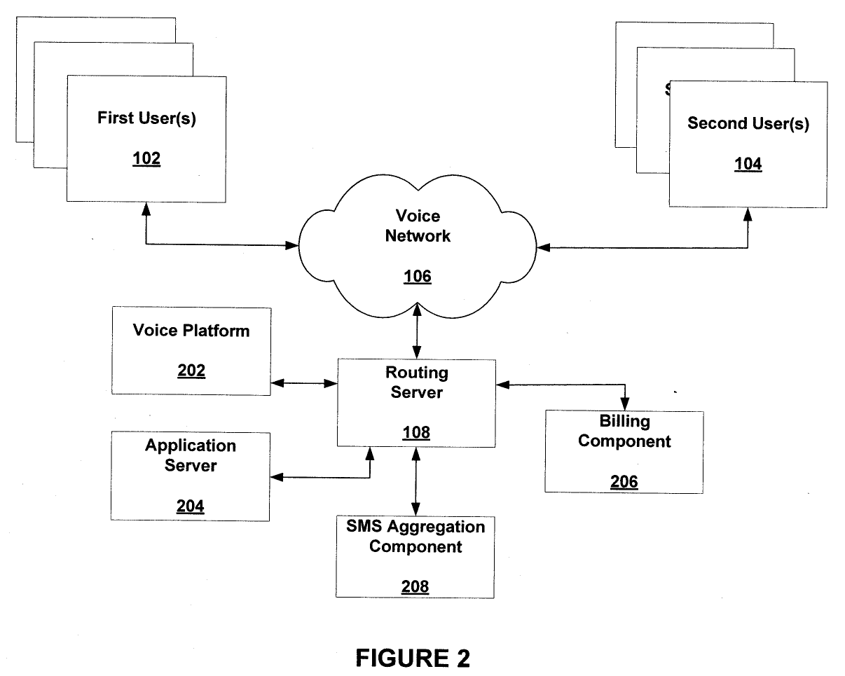

The routing server 108 may be coupled to one or more databases or storage mediums. The databases may include information regarding the relationship between the first user 102, the second user 104, and/or any other users along with the unique identifiers assigned to the first user 102, the second user 104, and/or any other users. Databases or other data storage for storing information associated with the one or more users is discussed further in association with FIGS. 2-5.

Referring now to FIG. 2, a schematic diagram of an exemplary architecture for providing sender-based routing over a voice network according to one embodiment is shown. As discussed herein, the first user 102 places a call (or generates any other communication that may be routed via the voice network 106) to the second user 104. Accordingly, the first user 102 is the sender. In other embodiments, the second user 104 may constitute the sender by initiating the call or other communication. The voice network 106 sends the call to the routing server 108 to be routed or consults the routing server 108 to determine where the call should be routed.

A voice platform 202 in communication with the routing server 108 provides voice services, such as speech recognition, interactive voice response (IVR), text-to-speech, and so forth. The voice platform 202 may also include a voice gateway for communicating voice communications to the routing server 108. Any components, servers, and so forth may be included as part of the voice platform 202 according to various embodiments.

An application server 204 in communication with the routing server 108 may be provided for providing various application services. For example, the application server 204 comprises one or more application servers, databases, and so forth. In exemplary embodiments, one or more databases or data storage, as discussed herein, may be provided for storing a subscriber directory that includes the unique identifiers for the senders, an application database, a logging database, a content database, and so forth. Any type of databases may be provided according to various embodiments.

A billing component 206 in communication with the routing server 108 may also be provided according to some embodiments. The billing component 206 may be utilized to assess charges accrued by the sender, such as the first user 102. According to exemplary embodiments, the billing component 206 provides billing data to the voice network 106. A party associated with the voice network 106 can then include the billing data on a bill issued for use of the voice network 106. In other embodiments, a party associated with the routing server 108 may issue a bill including the billing data directly to users, such as the first user 102 and/or the second user 104. Any type of billing system is within the scope of various embodiments.

An SMS aggregation component 208 may also be in communication with the routing server 108. The SMS aggregation component 208 processes text messages that are communicated to or from the first user 102 and/or the second user 104, according to exemplary embodiments.

In exemplary embodiments, the voice platform 202, the application server 204, and the routing server 108 comprise a sender-based routing system. However, any devices, components, and so forth may comprise the sender-based routing system according to other embodiments.

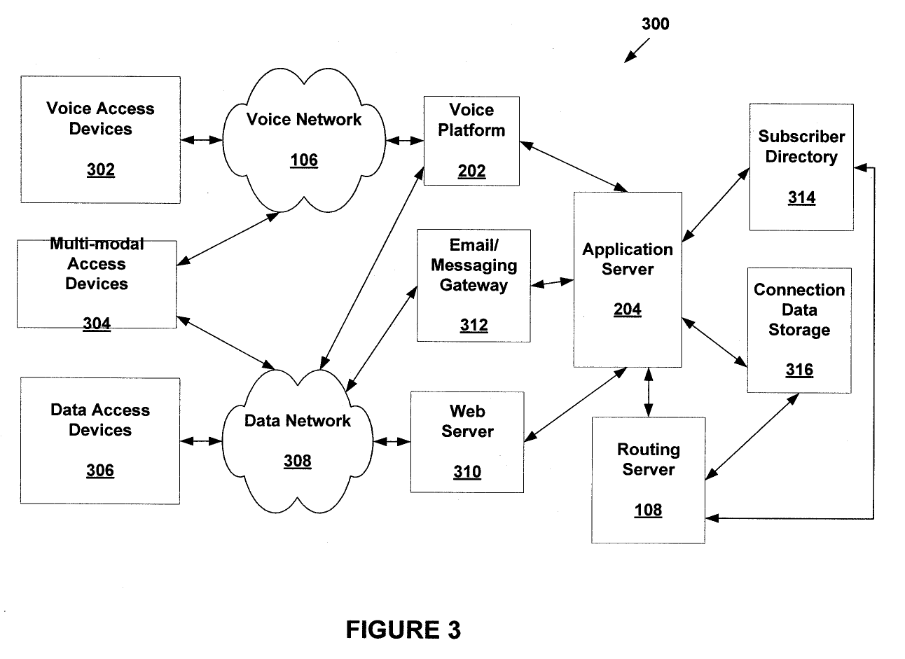

FIG. 3 illustrates a schematic diagram of an exemplary architecture for providing sender-based routing over a voice network and/or a data network according to one embodiment. Various voice access devices 302, such as a telephone, may be utilized to communicate voice communications via the voice network 106, as discussed herein. Thus, the first user 102 may utilize a voice access device 302 to call, text message, or otherwise communicate with the second user 104 via the voice network. In one embodiment, the voice network 106 routes the communication to the routing server 108 via the voice platform 202 and the application server 204.

The routing server 108 receives the communication and accesses a subscriber directory 314 to identify the sender based on the unique identifier issued to the sender, as discussed herein. The subscriber directory 314 may include various unique identifiers associated with each sender, each sender comprising a subscriber of the sender-based routing system 300.

A connection data storage 316 may be provided for storing various data about the various subscribers. For example, the connection data storage 316 may include a number of communication addresses associated with one subscriber, such as the first user 102. Accordingly, the application server 204 can utilize the unique identifier of the sender from the subscriber directory 314 to locate the communication address in the connection data storage 316. Using the unique identifier and the communication address, the application server 204 can communicate to the routing server 108 to which recipient, such as the second user 104, the call should be communicated.

Various data access devices 306, such as a laptop computer, and/or multi-modal access devices 304, such as a personal digital assistant, may be utilized to send data over a data network 308 utilizing the sender-based routing system 300 as well. A web server 310 may be provided as an interface for providing and updating data associated with the subscribers.

The web server 310 forwards the communication initiated by the data access device 306 and/or the multi-modal access device 304 to the application server 204. The application server 204 accesses the subscriber directory 314 and the connection data storage 316 to identify the sender and the intended recipient of the communication based on the unique identifier associated with the sender and the communication address entered via the data access device 306 or the multi-modal access device 304. The application server 204 instructs the routing server 108 where to route the communication.

Similarly, an email or other communication received via the data network 308 may be processed via an email/messaging gateway 312. The email or other communication is sent to the application server 204, which identifies the sender and the intended recipient by accessing information in the subscriber directory 314 and the connection data storage 316. The routing server 108 then routes the email or other communication to the appropriate recipient based on the data received from the application server 204.

Thus, the application server 204 determines the intended recipient of various communications received via the voice network 106 and/or the data network 308 and routes the various communications to the intended recipient via the voice network 106 and/or the data network 308. In some embodiments, the application server 204 receives communications via the voice network 106 and routes the communications to the intended recipient via the data network 308, and vice versa.

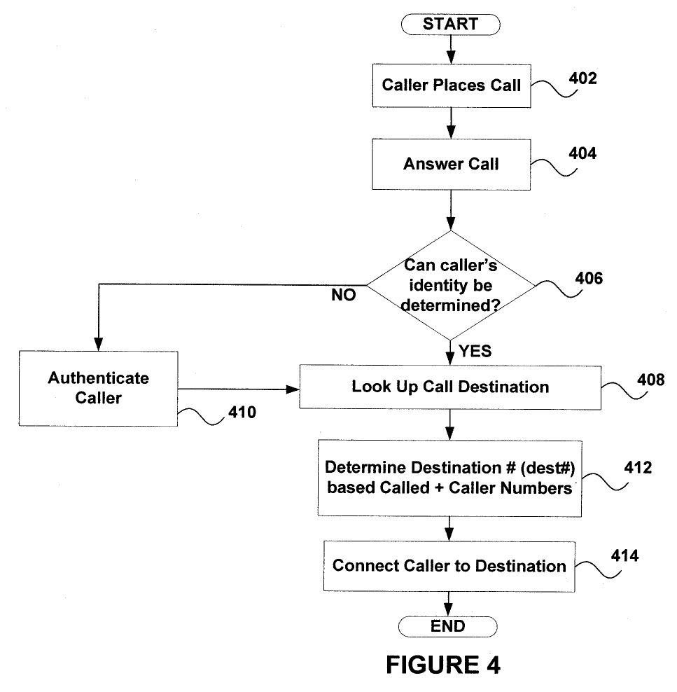

FIG. 4 shows a flow diagram of an exemplary process for routing telephone calls based on a unique identifier associated with the sender according to one embodiment. At step 402, a caller places a call. The caller may comprise the sender, as discussed herein, or any other user. According to FIG. 4, the caller places the call at step 402 by dialing a phone number. The phone number may comprise an anonymous phone number assigned to any number of users, as discussed herein.

At step 404, the call is answered. The call may be answered by the routing server 108 (FIG. 1) or by any other device or component. Once the call is answered, the routing server 108 or other device or component determines whether a caller's identity is available, at step 406. The caller ID may comprise the unique identifier associated with the caller, such as the sender. For example, the caller ID may comprise a phone number assigned to the caller placing the call. The caller's identity may be determined automatically, according to exemplary embodiments. The caller's identity may be determined from a caller ID program, voice printing, SIP authentication, and so forth. The phone number assigned to the caller may be stored in the subscriber directory 314 (FIG. 3) or any other data storage as discussed herein.

If the caller ID is available, the call destination is looked up at step 408. For example, the call destination may be looked up at the connection data storage 316 discussed in FIG. 3. The call destination may comprise an intended recipient for the call. For example, based on the unique identifier associated with the sender (i.e., caller) and a phone number dialed, the routing server 108 may determine to whom the call should be routed.

If the caller ID is not available at step 406, the caller is authenticated at step 410. Various methods may be employed for authenticating the caller at step 406. For example, the routing server 108 may request data from the caller in order to authenticate the caller. Any type of caller authentication process is within the scope of various embodiments. Once the caller is authenticated at step 410, the call destination is looked up at step 408, as discussed herein.

At step 412, the destination number is determined based on the number dialed, or otherwise entered, by the caller and the unique identifier, such as the caller's phone number, associated with the caller. More than one user, such as another caller or sender, may utilize the same number to initiate communication. However, the other caller or sender may be associated with a different unique identifier. Accordingly, the number dialed combined with the unique identifier associated with the caller can be utilized to determine the destination number so the caller can be connected with the intended recipient.

To illustrate, a first user, such as the first user 102 discussed in FIG. 1, may use a communication address, such as by calling a first telephone number, to establish a connection with a second user, such as the second user 104 discussed in FIG. 1. When the same first user 102 calls a second telephone number, a connection with a third user is established because the routing server 108 (FIG. 1) uses the unique identifier associated with the first user (i.e., the sender) and the telephone number called (i.e., the communication address) to route the call to the second user 104 using the first number and to the third user using the second number. A fourth user may also use the same first telephone number to establish a connection with a fifth user, or any other user, because the routing server 108 accesses data about each of the users that indicate the destination to which each of the users should be connected based on the unique identifier and the telephone number, for instance, to establish the appropriate connection.

At step 414, the caller is connected to the destination based on the destination number determined at step 412. Although the recipient may also be associated with a unique identifier, the routing server 108 can utilize the unique identifier associated with the caller and the number entered by the caller in order to determine the destination or intended recipient.

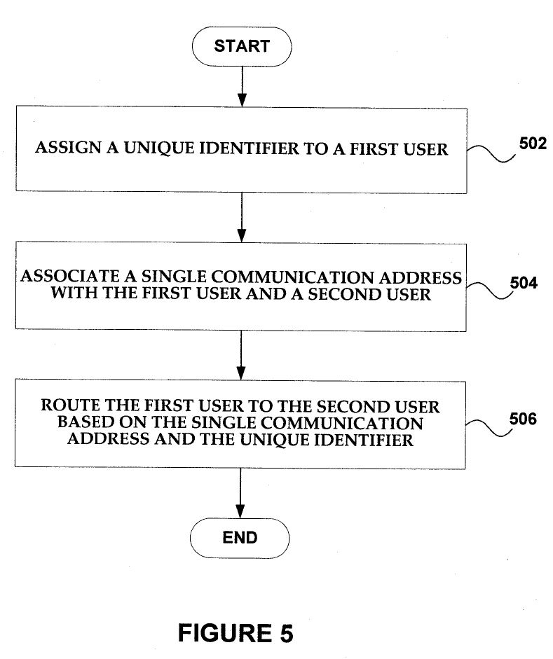

Referring now to FIG. 5, a flow diagram of an exemplary process for providing sender-based routing according to one embodiment is shown. At step 502, a unique identifier is assigned to, or otherwise associated with, a first user. As discussed herein, the unique identifier may comprise a communication address, such as a telephone number or email address, from which the first user communicates or any other type of unique identifier. For example, the unique identifier may be assigned to a user that comprises the sender or the caller discussed herein. Any type of user may comprise the first user 102 according to various embodiments.

At step 504, a single communication address is associated with the first user and a second user. The single communication address may comprise a telephone number, an email address, an instant message address, and so forth. The single communication address can comprise any address that may be utilized to allow communication between the first user and the second user. According to exemplary embodiments, a same single communication address may be assigned to more than the first user and the second user.

The routing server 108 (FIG. 1) or the application 204 (FIG. 2) may associate the single communication address with the first user and the second user. However, any device, party, component and so forth can associate the single communication address with the first user and the second user according to some embodiments. For example, a third party that represents the voice network 106 (FIG. 1) can associate the single communication address with the first user and the second user.

At step 506, a communication from the first user is routed to the second user based on the single communication address and the unique identifier. Thus, while other users may share the same single communication address, the combination of the single communication address and the unique identifier assigned to the first user indicates the destination to which a communication from the first user is routed. Accordingly, the first user may use one or more second single communication addresses to contact one or more third users.

Because the unique identifier associated with the first user combined with the single communication address determines the destination, the first user uses a different single communication address to contact the one or more third users. In other words, whenever the first user utilizes the first communication address, the first user is connected with, or otherwise in communication with, the second user. However, when the first user utilizes a second communication address, the first user is connected with a third user. Similarly, when the first user utilizes a third communication address, the first user is connected with a fourth user, and so forth.

According to alternate embodiments, the first user may be assigned more than one unique identifier. For example, a different unique identifier may be assigned to the first user for each recipient with which the first user wants to establish connections. In the alternate embodiments, the first user can utilize the same single communication address for various recipients (i.e., the second user, the one or more third users) and the communications may be routed to the various recipients based on the same single communication address and the different unique identifier assigned to the first user for each of the various recipients.

Although the routing server 108 is described as performing look up functions and routing the communications from the first user, such as the caller or the sender described herein, to the second user, any type of device or component may perform the same functions, or perform fewer or more functions, as those described in association with the routing server 108. For example, a third party may be utilized to route the first user to the second user based on information provided by the routing server 108.

According to some embodiments, data associated with a first user and a second user is received. For example, the routing server 108 may request registration data from the first user and the second user.

A single communication address is assigned to a combination of the first user and the second user. For example, a single telephone number may be assigned to the first user and the second user. The first user is then routed to the second user when the first user initiates a communication via the communication address. Thus, when the first user dials the phone number, the first user is routed to the second user. Similarly, the second user may be routed to the first user when the second user initiates a communication via the same communication address. Thus, if either the first user or the second user dials the telephone number assigned to the combination of the first user and the second user, the other party (i.e. the first user or the second user as the recipient) may be reached.

The first user and/or the second user is allowed to cancel the single communication address according to some embodiments. Thus, the first user and/or the second user can cut off or eliminate communication with the other party by canceling the communication address assigned to the first user and the second user. Further, because the single communication address is only assigned to the first user and the second user combination, the first user and the second user may remain anonymous to one another.

The routing server 108 can use a unique identifier associated with the first user and/or the second user to assign the same single communication address to various users. Thus, the routing server 108 determines that when the first user initiates communication utilizing the single communication address, the second user should be connected to the first user. When a third user utilizes the same communication address to initiate communication, however, the routing server 108 identifies the third user via the unique identifier and routes the third user to an intended recipient, such as a fourth user, which has been associated with the communication and the unique identifier. Accordingly, various pairs of users may be assigned the same single communication address. According to alternate embodiments, more than two users may be assigned the single communication address.

For example, users may be assigned different communications addresses with respect to communicating with different users. For example, a first user may be assigned a first address (e.g., 925-111-2222) for the purpose of reaching a second user. The second user may be assigned a second address (e.g., 925-333-4444) for the purpose of reaching the first user. A third user could be assigned the first address (i.e., 925-111-2222) for the purpose of reaching the second user and the second user could be assigned the second address (i.e., 925-333-4444) for the purpose of reaching the third user. Sender based routing, in such a scenario, allows for the re-use and effective allocation of addresses.

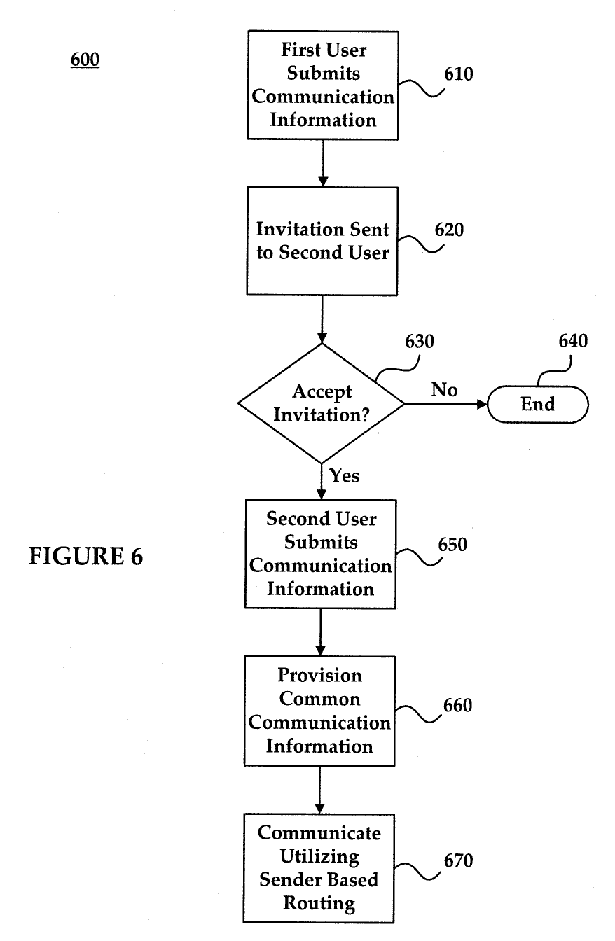

The aforementioned sender based routing schemes may be implemented in the context of two-way anonymous communications. Two-way anonymous communications may be offered by an anonymous communications network that is powered by an anonymous communications system. The communications network and related system may be implemented in the context of routing system 300 of FIG. 3 and as further discussed herein. By specific example, sender based routing may be implemented in voice communications utilizing standard phones and phone numbers as is illustrated in the method 600 of FIG. 6. As a result, users may communicate by phone (or other voice-enabled devices) without having to reveal their real or “private” phone number to another party. In such a method, users may initially communicate via electronic-mail or utilizing a messaging service offered by a social network or other web-based interactive community (e.g., a dating service). At some point, the users may wish to communicate by phone but without the aforementioned disclosure of real or “private” phone information.

In step 610, a first user (e.g., with a screen name of ‘macalias’) submits their real or “private” phone number (or other communication information such as an e-mail address) to a system offering anonymous communications features. This anonymous communication system may be integrated with or otherwise communicatively coupled to, for example, the routing system 300 as is illustrated in FIG. 3. This information may be provided via a graphic user interface (e.g., an Internet browser on a computer or mobile phone). The user interface may be offered by the aforementioned social networking community. The social networking community may also be integrated with the presently described anonymous communication system.

The user interface may be in communication with or an extension of application server 204, which may be a further part of routing system 200 as illustrated in, for example, FIG. 2. Information provided through a user interface may function as a data set that is collected and subsequently utilized by a scripting application to ‘enroll’ a user in an anonymous communications network. Application server 204 may operate in conjunction with a routing server 108 and subscriber directory 314 as further described in the context of FIG. 3.

In step 620, an invitation to communicate with the first user using the system offering anonymous communication features is sent to the second user (e.g., with a screen name of ‘roboliz12’). This invitation may be delivered via electronic-mail or SMS text message by a communications server operating within the context of the anonymous communications system. The invitation may also be delivered via a messaging application that is native to a social network (e.g., a community bulletin board or instant messenger application). In some embodiments, the invitation may be delivered by an invitation generation module (not shown) that is a part of application server 204.

A software module or application, as referenced in the context of the present invention, should be generally understood as a collection of routines that perform various system-level functions. A software module may be dynamically loaded and unloaded by hardware and device drivers as required. The modular software components described herein may also be incorporated as part of a larger software platform or integrated as part of an application specific component.

In step 630, the second user (roboliz12) may accept or reject the invitation to communicate anonymously with the first user (macalias) through the communication network or other community offering anonymous communications. Should the second user (roboliz12) reject the invitation in step 630, the method 600 comes to an end at step 640. The first user (macalias) that caused the invitation to be issued may be sent a notification by e-mail or some other messaging system indicating that the invitation has been declined by the second user (roboliz12). The two users may subsequently continue to communicate as before (i.e., without voice interaction) and/or the invitation may subsequently be reissued. In some embodiments, the notification may indicate reasons why the second user (roboliz12) rejected the invitation. The reasons reflected in the notification may be selected from a list of available reasons (e.g., as may be offered in a drop-down menu). Alternatively, the reasons may be custom generated by the second user (e.g., a personalized message detailing the reasons).

The first user (macalias) may skip step 610 if the first user (macalias) is already a registered user or has already provided certain information to the anonymous communication network. In this case, the method 600 may actually commence at step 620 with respect to issuance (or re-issuance) of the invitation to the second user (roboliz12). The first user (macalias) may also seek to invite a third user (e.g., with a screen name of johndoe) or any number of other users to join the communications network and engage in anonymous two-way communications. The method may again commence at step 620 with respect to issuance of an invitation to the third user (johndoe) as the first user (macalias) has already registered with the network.

Should the second user (roboliz12) accept the invitation in step 630, the second user will submit their real or “private” phone number (or other communication information) in step 650. The second user (roboliz12) (or the first user or any other user enrolling in the anonymous communication network) may provide additional information beyond a phone number (e.g., name, address, etc.). Certain information may be derived from other integrated sources of information. For example, user aliases and other information may be acquired from a user profile previously generated as a part of the aforementioned social network. Upon acceptance of the invitation by the second user (roboliz12), the first user (macalias) may be sent a notification that the invitation has, in fact, been accepted. The acceptance notification may include additional information including a personalized message concerning the acceptance.

In step 660, a common phone number (or, depending on the particular communications medium, some other communication identification such as an instant messenger ID) is provisioned by the anonymous communications network. This system-assigned phone number (or other communications identification) that is common to the two users may be generated by a provisioning module (not shown) that is a part of application server 204. Application server 204 may be in communication with subscriber directory 314 as is discussed in the context of FIG. 3 in order to ensure proper routing of communications utilizing this system-assigned number.

In some embodiments, each user may be assigned their own unique communication address. For example, the first user (macalias) may be assigned a particular number for communications with the second user (roboliz12) (e.g., 1-555-987-6543). The second user (roboliz12) would, in such an embodiment, be assigned a particular number for communications with the first user (macalias) (e.g., 1-555-345-6789). A particular user may be associated with both a single, common number and/or unique individual numbers at the same time but with respect to different users.

Both the first user (macalias) and second user (roboliz12) are then informed of the allocation of this common number (or each individual number as the case may be) via, for example, electronic mail or some other messaging system as may be native the aforementioned social network and/or anonymous communications network. In some embodiments, this system-assigned number may be displayed in a user profile of one user vis-à-vis the second user (i.e., a profile of roboliz12 as viewed by macalias may reflect the system-assigned number common to both users).

In step 670, the first user (macalias) and the second user (roboliz12) may communicate using this system-assigned number and the sender-based routing techniques as discussed in the context of, for example, FIG. 4. For example, the first user (macalias) may dial the system-assigned number (e.g., 925-434-4545) in an effort to contact the second user (roboliz12). The routing server 108 may answer the call (step 404 of FIG. 4) and determine the caller's identity (step 406 of FIG. 4). By subsequently looking up the call destination and determining the destination number (steps 408 and 412 of FIG. 4), the caller (macalias) may be connected with the second user (roboliz12).

The anonymous communications system described herein advantageously allows two users to “opt-in” to the anonymous communications network. The voice communications may be anonymous since a common, single communication address (i.e., the system-assigned number) may be assigned to a first user and a second user. The first user and the second user may utilize the common, single communication address to communicate with one another without any other information about each user. Because the anonymous communication system is utilizing a real phone number, the second user (roboliz12) can, for example, put the first user (macalias) in her phone contacts thereby allowing her to take advantage of such features as caller ID, name look-up, caller-specific ring tones, and photo caller ID.

The communication address may be disposable in that it expires and may be re-assigned after a single use, a predetermined period of time, a predetermined number of uses, or upon one of the users opting out of further communications utilizing the particular address. Further, and because of the sender-based routing functionality as discussed in the context of FIG. 4, the same communication address may also be concurrently utilized by other users. For example, a fourth user (e.g., with a screen name of joeynyc) may be assigned the same number as the first user (macalias) and the second user (roboliz12) (i.e., 925-434-4545) with respect to communications with a fifth user (e.g., with a screen name of suzyque). The routing server 108 and related directories and applications (e.g., subscriber directory 314) will determine that when the system-assigned number (i.e., 925-434-4545) is dialed by first user (macalias) that the intended recipient is the second user (roboliz12) whereas calls initiated by the fourth user (joeynyc) are intended for the fifth user (suzyque).

In some embodiments, when the first user (macalias) contacts the second user (roboliz12) utilizing the system-assigned number (i.e., 925-434-4545), the first user (macalias) may be prompted to record a short caller introduction. The second user (roboliz12), following sender-based routing of the call, may receive the recorded introduction and elect whether or not to receive the call from the first user (macalias). This call screening functionality may be offered by application server 204 in conjunction with voice platform 202 as described in the context of FIG. 2. This call screening functionality offers an additional layer of privacy beyond that of the anonymity already offered by the system-assigned number. Depending on the particular format of communication (e.g., electronic-mail or instant messenger), the introduction may be a textual message. In some embodiments, an introduction may be recorded and subsequently associated with a hyperlink. This hyperlink may be embedded in the aforementioned textual message whereby a recipient clicks on the link and hears the introductory message notwithstanding the otherwise non-audible communications medium.

Similar two-way anonymous communications may be offered with respect to SMS/text messaging and the aforementioned system-assigned number. In such an example, routing server 108 may operate in conjunction with SMS aggregation component 208 in order to facilitate the sender-based routing functionality disclosed herein. The features described with respect to a system-assigned number for voice communications may also be applicable to SMS/text messaging.

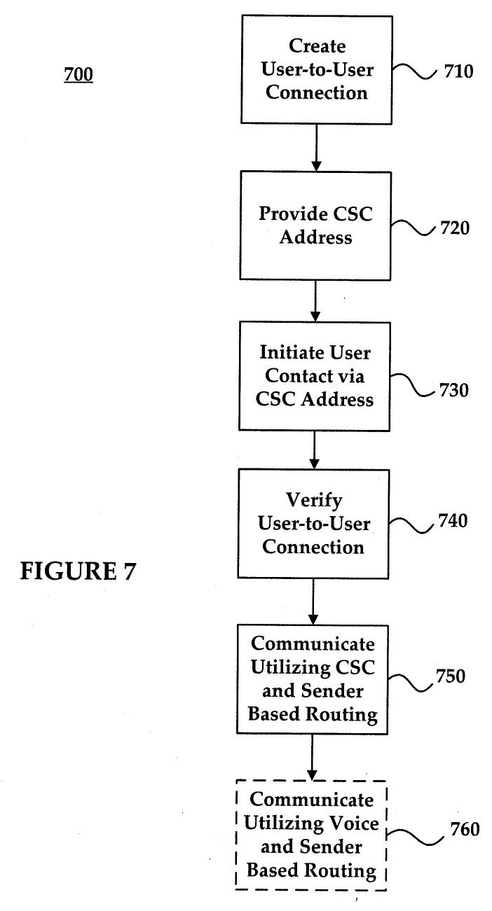

Two-way anonymous communications may also occur in the context of common short code (CSC) messaging as shown in the method 700 of FIG. 7. In step 710, two users (e.g., macalias and roboliz12) create a connection in a social network or anonymous communications network. The creation of this indication is indicative of both users' permission to engage in anonymous communications with one another and/or other users of the network. This connection may be as simple as indicating approval of allowing anonymous communications with another user via an affirmative response to an invitation or may involve a negotiated acceptance protocol that may include various privacy settings and the like.

In step 720, a CSC address is provided (e.g., 52645) by a social or anonymous communications network. A short code address is a number that is typically five digits in length and used in SMS messaging. Instead of a longer number such as a ten digit phone number, short codes are generally easier to remember due to length and, in some instances, a related product (e.g., 52645 for Jangl). Short codes are universally applicable to SMS carriers. For example, a text message sent to 52645 on a Cingular wireless network will be delivered to the same recipient as it would be on a Verizon Wireless network.

In step 730, a first user (macalias) sends a text message via the CSC 52645. The text message includes in its body an identification of a recipient—the second user (roboliz12). The routing server 108, in step 740, identifies the sender by their alias and verifies that a connection exists between the sender (macalias) and the intended recipient (roboliz12). Information concerning the existence of a connection may be maintained in connection data storage 316. If no connection exists, the attempted communication may be blocked or terminated. Information concerning the termination may be provided to the sender of the communication via any variety of communications means.

Should a connection be determined to exist, the routing server 108, which may operate in conjunction with an SMS aggregation component 208 and/or e-mail/messaging gateway 312, then routes the SMS message to the second user in step 750. The second user, as noted above, will have been identified through addressing information included as a part of the SMS message. A similar process may occur with respect to a reply from the second user (roboliz12) to the first user (macalias) utilizing sender based routing of the SMS message via the CSC. In optional step 760, the two users may then communicate utilizing anonymous voice communications as discussed above.

Two-way anonymous communications may also be offered in the context of electronic-mail addressing. In such an embodiment, the two users register their real e-mail addresses (e.g., macster@hotmail.com and lizgirl@yahoo.com) with the network in a fashion similar to that described in steps 610 and 650 of FIG. 6. Issuance of invitations and rejection/acceptance of those invitations may also be implemented in the context of anonymous e-mail addresses like that disclosed in steps 620-640 of FIG. 6. A provisioned electronic-mail address is then provided to both users in a manner similar to that of step 660 of FIG. 6 as it pertained to phone numbers for voice communications (e.g., flink1022@jangl.com).

Future communications between macster@hotmail.com and lizgirl@yahoo.com utilizing the flink1022@jangl.com address are intelligently routed utilizing sender based routing functionality by the routing server 108. The routing server 108, in such an embodiment, may operate in conjunction with email/messaging gateway 312 as described in the context of FIG. 3. Like the system-assigned phone numbers, a single e-mail address (i.e., flink1022@jangl.com) may also be used by multiple parties (e.g., mrjoe@gmail.com to contact sue.smith@corp.com and vice versa as well as the aforementioned macster@hotmail.com with lizgirl@yahoo.com). Like voice communications and SMS/text-messaging, the features disclosed thereto may also be applied in the context of anonymous electronic-mail communications.

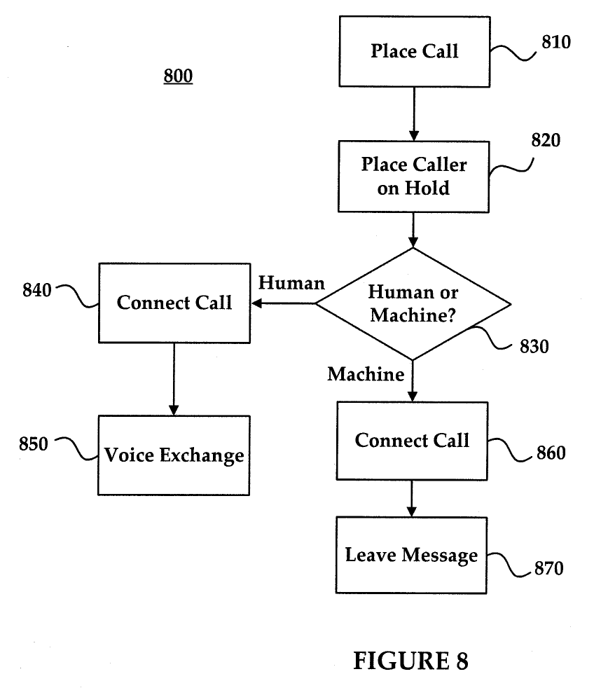

FIG. 8 illustrates a method 800 for anonymous voice messaging. In method 800, a calling party may leave a voice message for a recipient without the recipient's voice mail greeting being played for the calling party. Such a methodology may be beneficial with respect to maintaining the anonymity and/or privacy of the recipient with respect to anonymous or otherwise unknown callers. For example, a voice mail message that provides the recipient's real name and/or other information (e.g., “I am out of town for the week” or “you have reached 1-123-456-7890”) may be freely and intentionally made available to known callers (i.e., persons having the recipient's private number). Disclosure of this information may be undesirable in the context of anonymous callers contacting the recipient through an anonymous communications network (e.g., via a system-assigned number). This methodology may be implemented in the context of server-based voice mail as may be offered by a telecommunications provider or a traditional answering machine.

In step 810, a call is placed utilizing an anonymous contact mechanism (e.g., a system-assigned phone number utilizing sender based routing). In step 820, the call (following sender based routing) is received at the routing server 108 and the caller is placed on hold by a voice messaging module (not shown). The voice messaging module may be implemented, for example, in the context of voice platform 202 or application server 204. While the caller is placed on hold in step 820, the routing server 108 completes the connection to the intended recipient as may be determined by sender based routing.

The caller is placed on hold so that a determination may be made by the voice messaging module in step 830 as to whether the recipient of the call is a human (the actual recipient) or a voice messaging system. During the time that the caller is placed on hold, the caller may be exposed to ‘on hold’ music, advertisements, or other informational recordings. The voice messaging module may make this determination by detecting certain human initiated dual tone, multi-frequency (DTMF) input. Alternatively, the system may make the determination by listening for the ‘beep’ or ‘tone’ that accompanies an outgoing message in a voice messaging system.

DTMF input may be indicative that a human has picked up the phone and that no outgoing voice message with personal information is being played. A human recipient may, upon receipt of the sender based routed call, input a certain code utilizing the keypad of their phone. By depressing the individual buttons on their phone keypad, two simultaneous tones are generated (one for the row and one for the column). These dual tones may be decoded and interpreted by the voice messaging module or some other application in the anonymous communications system to determine that a human has picked up the phone. The call may then be connected in step 840 and the two parties may engage in a voice exchange in step 850.

In some embodiments, an audio announcement may be made to the recipient by the anonymous communications system to indicate that a sender-based and otherwise anonymous phone call is incoming. This announcement may be made shortly after the routing server 108 (although not the caller) and the recipient are initially connected. The recipient may either hang up the call or enter a particular code to allow the call to be connected in step 840.

Alternatively, if no DTMF input is detected and the voice mail ‘beep’ or ‘tone’ has been issued by the recipient voice messaging system and detected by the voice messaging module, then it is likely that a human recipient has not picked up the phone. Further, presuming a voice mail message to have preceded the ‘beep,’ any information that may have been provided in the outgoing voice mail message has already been played. This information, however, has not heard by the caller as the caller remains on hold. Once the beep is detected, however, the call is connected (i.e., the caller is taken off hold) between the caller and the recipient's voice mail system in step 860. The caller may then leave a message in step 870.

In some embodiments, the caller may never be connected directly with the recipient's voice mail system. In such an embodiment, the caller may actually leave their message with the voice messaging module of the anonymous communications system. The communications system may then subsequently contact (or re-contact) the intended recipient and playback and/or leave the message on the recipient's voice mail system. Such an embodiment may be useful in the instance that the recipient picks up the phone but then makes a determination that they do not wish to speak to the caller.

This determination may be aided by an initial voice introduction recorded by the caller (prior to or while having been placed on hold) and played back by the voice messaging module to the intended recipient. The brief message, which may be of a limited duration (e.g., five to ten seconds), may indicate the particular reasoning for the call and provide some indication to the recipient as to whether they should accept the call or redirect the call to a voice mail system. The recipient, upon determining the identity of the caller or the purpose of the call, may provide DTMF input that correlates to an instruction for the anonymous communication system to ‘take a message.’ The anonymous communication system may later provide the message to the intended recipient via call-back or a direct exchange with the recipient's voice mail system.

While various embodiments have been described above, it should be understood that they have been presented by way of example only, and not limitation. For example, any of the elements associated with the sender-based routing may employ any of the desired functionality set forth hereinabove. Thus, the breadth and scope of a preferred embodiment should not be limited by any of the above-described exemplary embodiments.

What is claimed is:

1. A method for providing anonymous communication addresses, the method comprising:
receiving data associated with a first user and a second user;
assigning a common, single communication address to both the first user and the second user; and
routing a communication between the first user and the second user when either user initiates a communication with the other user via the common, single communication address, wherein the routing is based on at least the data associated with the first user or the second user.

2. The method of claim 1, wherein the common, single communication address expires after a predetermined period of time.

3. The method of claim 1, wherein the common, single communication address expires after a predetermined number of uses.

4. The method of claim 1, wherein the common, single communication address expires upon an indication by one of the users that they no longer wish to communicate via the common, single communication address.

5. The method of claim 1, wherein the common, single communication address may be re-assigned to a new user after expiration.

6. The method of claim 1, wherein the common, single communication address may be concurrently assigned to a third and fourth user, wherein a communication is routed between the third and fourth user when either the third or fourth user initiates a communication with the other user via the common communication address.

7. A method for providing an anonymous communication address in a social network, the method comprising:
receiving registration data from a first user associated with the social network;
sending an invitation to a second user associated with the social network informing the second user of a desire by the first user to communicate with the second user;
assigning a common, single communication address to both the first user and the second user after having received registration data from the second user, the second user having accepted the invitation from the first user; and
routing a communication between the first user and the second user when either user initiates a communication with the other user via the common, single communication address, wherein the routing is based on at least the registration data associated with the first user or the second user.

8. The method of claim 7, wherein the registration data received from the first user is provided via a graphic user interface.

9. The method of claim 8, wherein the registration data received via the graphic user interface is utilized by a scripting application to enroll the first user in the social network.

10. The method of claim 7, wherein the social network is communicatively coupled to a sender based routing system.

11. The method of claim 7, wherein the social network is an application offered by a sender based routing system.

12. The method of claim 7, wherein the social network is a dating service.

13. The method of claim 7, wherein the invitation is delivered by electronic-mail.

14. The method of claim 7, wherein the invitation is delivered by SMS.

15. The method of claim 7, wherein the invitation is delivered by a messaging application native to the social network.

16. The method of claim 15, wherein the messaging application is an instant messenger application.

17. The method of claim 15, wherein the messaging application is a bulletin board.

18. The method of claim 7, wherein the acceptance of the invitation by the second user results in a notification message being sent to the first user.

19. The method of claim 20, wherein the notification message includes a personalized message concerning the acceptance of the invitation.

20. The method of claim 7, wherein the common, single communication address is a phone number.

21. The method of claim 7, wherein the common, single communication address is an e-mail address.

22. The method of claim 7, wherein the common, single communication address is an instant messenger alias.

23. The method of claim 7, wherein the common, single communication address is generated by a provisioning module at an application server, the application communicatively coupled to a routing server, the routing server configured to receive a communication from a sender of the communication and route the received communication based on a sender alias as identified from information retrieved from a subscriber directory.

24. The method of claim 7, wherein the common, single communication address is displayed in a profile of the first user when the profile of the first users is viewed by the second user, the profile of the first user having been generated by the social network.

25. The method of claim 7, further comprising:
prompting the first user to record an introductory message to the second user prior to the communication being routed from the first user to the second user;
playing the introductory message recorded by the first user to the second user;
offering the second user an option to accept or reject the communication from the first user following play back of the introductory message.

26. The method of claim 25, wherein the introductory message is recorded by a voice platform communicatively coupled to a routing server, the routing server configured to receive a communication from a sender of the communication and route the received communication based on a sender alias as identified from information retrieved from a subscriber directory.

27. A method for providing an anonymous voice mail service, the method comprising:
receiving a communication from a first user;
placing the first user on hold;
determining whether a second user intended to be contacted by the first user will accept the communication or whether the communication will be accepted by a voice mail service, and if a determination is made that the communication will be accepted by the voice mail service, maintaining the first user on hold until an outgoing voice mail message associated with the second user ends; and
routing the first user to the second user, wherein the first user is allowed to leave a voice mail message after the outgoing voice mail message associated with the second user ends.

28. The method of claim 27, wherein the if a determination is made that the communication will be accepted by the second user, routing the first user to the second user for a person-to-person voice communication, wherein the first user is routed to the second user utilizing sender based routing.

29. The method of claim 27, wherein the voice mail service is an answering machine.

30. The method of claim 27, wherein the voice mail service is a server-based voice mail service.

31. The method of claim 27, wherein the communication from the first user is received by a routing server.

32. The method of claim 27, wherein music is played to the first user while on hold.

33. The method of claim 27, wherein an advertisement is played to the first user while on hold.

34. The method of claim 27, wherein an informational recording is played to the first user while on hold.

35. The method of claim 27, wherein the determination as to whether the communication will be accepted by a voice mail service includes detecting human initiated dual tone multi frequency input.

36. The method of claim 27, wherein the determination as to whether the communication will be accepted by a voice mail service includes detecting a voice mail tone, the tone indicating that a caller should commence leaving a voice mail message.

37. The method of claim 35, wherein the dual tone multi frequency input indicates that the communication from the first user should be routed to the second user.

38. The method of claim 35, wherein the dual tone multi frequency input indicates that the communication from the first user should be routed to the voice mail service.

39. The method of claim 27, further comprising issuing an audio announcement to the second user that the communication from the first user is a sender based, anonymous communication.

40. A method for providing anonymous communication addresses, the method comprising:
receiving data associated with a first user and a second user;
assigning a communication address to the first user, the communication address being associated with communications initiated by the first user and intended for the second user as reflected by the data associated with the first user;
assigning a communication address to the second user, the communication address being associated with communications initiated by the second user and intended for the first user as reflected by the data associated with the second user; and
routing a communication between the first user and the second user when the first user initiates a communication with the second user using the communication address assigned to the first user; and
routing a communication between the second user and the first user when the second user initiates a communication with the first user using the communication address assigned to the second user.
